(19) United States
(12) Patent Application Publication
(10) Pub. No.: US 2009/0021568 A1
(43) Pub. Date: Jan. 22, 2009

(54) Reactive Dye and Process of Printing Same

(76) Inventor: Ming Xu, Malvern, PA (US)

Correspondence Address: B. CRAIG KILLOUGH, P. O. DRAWER H, CHARLESTON, SC, 29402, US

(21) Appl. No.: 12/064,376

(22) PCT Filed: Aug. 28, 2006
(86) PCT No.: PCT/US06/33316

§ 371 Date: Feb. 21, 2008

Related U.S. Application Data
(60) Provisional application No. 60/711,806, filed on Aug. 26, 2005.

(51) Int. Cl. B41J 2/17

(52) U.S. Cl. 347/96

(57) ABSTRACT

A method of printing an ink that comprises reactive dyes as colorants. The ink has at least one cyclodextrin (CD) compound to react with reactive dye molecules, while a hydrophobic cavity is filled with a disperse dye component to create an encapsulation prior to the ink formulation stage. The ink also includes a crosslinking agent that is capable of creating a chemical bonding reaction between the unreacted portion of the hydroxyl functional groups of cyclodextrin (CD), an optional alkaline substance, and other optional ink additives. Permanently bonded color images are provided by the reaction between the chemically altered and colored cyclodextrin (CD) and the final substrate, which may be any cellulosic, protein, or polyamide fiber material, or mixtures with polyester, by the application of energy.

This application claims the benefit of priority from earlier filed provisional patent application Ser. No. 60/711,806, filed Aug. 26, 2005.

### FIELD OF THE INVENTION

This invention relates to printing generally, and more specifically, to a reactive dye which may be thermally printed from a substrate, and a method of printing the reactive dye.

### BACKGROUND OF THE INVENTION

Words and designs are frequently printed onto clothing and other textile materials, as well as other objects. The use of digital computer technology allows a virtually instantaneous printing of images. For example, video cameras or scanning may be used to capture an image to a computer. The image may then be printed by a computer driven printer, including thermal, ink jet, and laser printers. Computer driven printers are readily available which will print in multiple colors.

Heat activated, or sublimation, transfer dye solids change to a gas at about 400° F., and have a high affinity for polyester at the activation temperature. Once the gasification bonding takes place, the ink is permanently printed and highly resistant to change or fading caused by laundry products. While sublimation dyes yield excellent results when a polyester substrate is used, these dyes have a limited affinity for other materials, such as natural fabrics like cotton and wool. Accordingly, images produced by heat activated inks comprising sublimation dyes which are transferred onto textile materials having a cotton component do not yield the high quality images experienced when images formed by such inks are printed onto a polyester substrate. Images which are printed using sublimation dyes applied by heat and pressure onto substrates of cotton or cotton and polyester blends yield relatively poor results.

Color intensity and vividness are difficult to achieve by using a single type of colorant. The requirement for lengthy and chemically hazardous treatments including pretreatment and after-treatment of the fabric and wash waste in the case of reactive dye processes further emphasizes the need of an improved digital printing method.

### SUMMARY OF THE INVENTION

This invention is a method of printing an ink which comprises reactive dyes, known for high washfastness, and disperse dyes, known for creating color vividness, as colorants with at least one cyclodextrin (CD) compound. Hydrophilic hydroxyl or alkylhydroxyl functional groups of such a cyclodextrin (CD) compound react with the reactive dye molecules, while the hydrophobic cavity is filled with a disperse dye component to create an ‘encapsulation’ prior to the ink formulation stage.

The ink of the present invention also includes a crosslinker chemical or agent that is capable of creating a chemical bonding reaction between the unreacted portion of the hydroxyl functional groups of cyclodextrin (CD), an optional alkaline substance, and other optional ink additives. Permanently bonded color images are provided by the reaction between the chemically altered and colored cyclodextrin (CD) and the final substrate, which may be any cellulosic, protein, or polyamide fiber material, or mixtures with polyester, but not until heat activation of the printed ink image.

A digital printer prints an image onto a substrate at a relatively low temperature, so that the ink is not activated during the process of printing onto the medium. The image formed by the printed ink is thereafter fixed to the substrate on which the image is to permanently appear, such as by the application of heat and pressure which activates the ink and allows the heat activated colorant or sublimation dye to activate and permanently bond to the synthetic material onto the substrate. The process produces an image on the final substrate with rich and intense color and also is water-fast and color-fast.

Alternatively, a digital printer prints an image onto an intermediate substrate with the ink, followed by a transfer process with application of sufficient heat and pressure which activates, or fixes the ink and permanently bonds the image to the final substrate.

It is yet another preferred embodiment of the present invention to produce an inkjet ink which can either be aqueous, non-aqueous, or hot-melt phase change solid, depending on a specific application.

### DESCRIPTION OF THE PREFERRED EMBODIMENTS

Cyclodextrins (CD) are chemically and mechanically stable cyclic oligosaccharides consisting of glucopyranose units. These oligosaccharides have cone or doughnut shaped structures with monomolecular hosts in a supramolecular chemical with a hydrophilic surface and a hydrophobic cavity space. Similar to cellulose or chemically modified cellulose, hydroxyl or alkylhydroxyl functional groups from glucopyranose units are capable of reacting with other chemicals through various chemical reaction processes to alter properties such as solubility, chemical reactivity, and the color of the compound. Molecules with adequate size and shape and compatible chemical functionality can be held, hosted, or encapsulated within the cavity. Forces creating such encapsulation may be electrostatic, van der Waals, hydrophobic interactions or hydrogen bonding. The molecules, generally referred to as “inclusion compounds,” held within the cavity may be released under appropriate conditions such as temperature gradient or pressure change, depending on the specific encapsulation and the nature of the chemicals that are encapsulated. Due to the hydrophilic property of the surface structure, most cyclodextrins (CD) have a relatively high solubility in water carrier.

Generally, there are three different types of cyclodextrin (CD) compounds: α-, β, and γ-cyclodextrins (CD). Each has a different cavity size and therefore is only suitable for certain molecules through a size exclusion process. Furthermore, cyclodextrins (CD) are also categorized as either non-branched or branched cyclodextrin (CD), where one or more molecule(s) of one or more oligosaccharide(s) has been bonded with an extra glucose or similar unit with improved properties such as water solubility. Many different chemical functional groups or moieties can be introduced into the cyclodextrin (CD) structure through chemical reactions between the hydroxyl/alkylhydroxyl groups and other functional groups such as alkyl, amine, hydroxyalkl, carboxyalkyl, acetyl and the like. These modified cyclodextrin (CD) compounds possess different chemical and physical properties compared with the untreated cyclodextrins, and generally are referred to as chemically modified cyclodextrin (CMCD). All these cyclodextrins may be used either singly or in combination in the present invention and the term cyclodextrin (CD) is used to include all these variations in the following discussions.

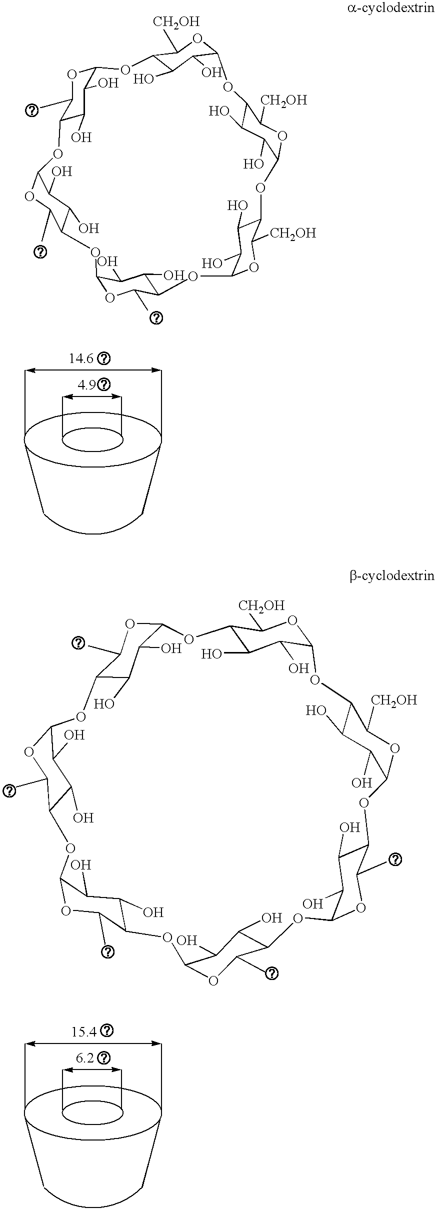

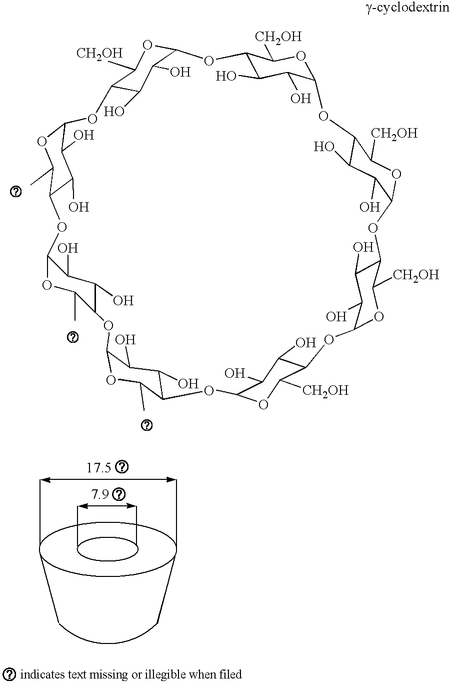

A reactive dye is defined here as a colorant that is capable of forming a covalent bond between a carbon or phosphorous atom of the dye ion or molecule and an oxygen, sulfur, or nitrogen atom of a hydroxy, mercapto, or amino group, respectively, of the final substrate. The reactive dye can form a chemical bond with the hydroxyl or alkylhydroxyl group in cellulose fibers, such as cotton, linen, viscose, and Lyocell; with the mercapto or amino groups in the polypeptide chains of protein fibers, such as wool and silk; or with the amino groups in polyamide fibers, such as nylon 6.6 and nylon 6.

In a preferred embodiment of the present invention, a cyclodextrin (CD) compound is to react with a reactive dye compound through exhaustion dyeing or continuous dyeing processes to create a permanent bonding between the dye and the cyclodextrin compound, depicted by the following equations:

CD-OH+OH⁻→CD-O⁻+H₂O

CD-O⁻+X⁻→CD-O-Dye+X⁻

At least a portion of the hydroxyl or alkylhydroxyl functional groups (such as hydroxyethyl, or hydroxypropyl) are reacted with the reactive dyes. The remaining portion for the hydroxyl or alkyhydroxyl functional groups, along with other functional groups such as vinyl, phenol, sulfonic, carboxyl, and the like, are used to create a bonding reaction with the substrate. The degree of reaction can be controlled by the concentration of each ingredient including alkali, salt, and solvent, and reaction parameters, such as temperature and time. After the dyeing reaction, excess chemicals may be removed by separation processes such as extraction, neutralization, and purification processes such as washing. One skilled in the art of dyeing can refer to “Textile Dyeing and Coloration”, (J. R. Aspland, Published by American Association of Textile Chemists and Colorists, 1997) for suitable detailed processes.

Not all hydroxyl and alkylhydroxyl groups have the same reactivity in bonding with reactive dyes. In order to allow cyclodextrin to have complete reaction with reactive dyes, an extra amount of time or chemicals may be applied during the exhaustion or continuous dyeing process. On the other hand, those hydroxyl or alkylhydroxyl groups that are difficult to react are also difficult to remove through the reversible reactions as illustrated by the following equations:

CD-O-Dye+X⁻ [symbol] CD-O⁻+X⁻

CD-O⁻+H₂O [symbol] CD-OH+OH⁻

Therefore, the reverse process of dyeing can be used to further control the degree of the reaction, leaving the most reactive hydroxyl and/or alkylhydroxyl functional groups for crosslinking with the printing substrate such as cellulose fibrous materials. Preferably, the final molar ratio of active hydroxyl and alkylhydroxyl to reactive dye functional groups is from 0.1:1 to 10:1, and most preferably from 0.5:1 to 2:1.

Heat activated colorants, such as disperse dyes or sublimation dyes may then be introduced into the hydrophobic cavities of the cyclodextrin (CD) cone structure. Depending on the molecular size and structure of the colorant or the dye, α-, β-, or γ-cyclodextrins (CD) may be used either alone or in combination. Such an introduction or encapsulation is advantageous for liquid ink applications since a stable formulation can be obtained without using substantial amounts of dispersant, emulsifying agent, and emulsifying enforcing agent, which may otherwise be critical in forming the ink comprising such colorants, either in aqueous or non-aqueous systems.

The encapsulation process which introduces disperse or sublimation dyes into the hosting cyclodextrin (CD) cavities can be carried out in either a solvent system or aqueous system with cosolvent so that a certain solubility of the dyes can be achieved prior to the encapsulation into the hosting structure. For example, a mixture of cyclohexane-pyrrolidinone (CPY) and dimethylformalmide (DMF) may be used for the process, followed by separating the completed reactive dyed and sublimation dye encapsulated cyclodextrin (CD) from the solvent mixture. Direct sublimation processes may also be used, but caution must be taken in order to allow sufficient time that a controlled amount of disperse or sublimation dyes can be hosted to completion. Pressurized reactors may be used to maintain the sublimation dye gas concentration for a period of time. The extra amount of unhosted dyes may be removed through various washing techniques.

The encapsulation process of the present invention is useful for creating unique colors of the ink and the image on the final substrate by adjusting ratios between the reactive dye bonded on the cyclodextrin and the hosted disperse or sublimation dyes. Expanded color or shade can be achieved, whereas they may not be obtained by either type of colorant alone. Furthermore, other inclusion compounds or colorants may also be encapsulated through similar processes for the purpose of enhancing the functionality of the final substrate with a printed image. For example, a pegylated inclusion compound may carry active pharmaceutical ingredients into such cyclodextrin (CD) structures with its pegylation chain inserted either in or through the cone cavity, while the color-coding of the dye or dyes gives the clear indication of the materials without chemical analysis for identification.

The method used in the present invention is especially suitable for disperse or sublimation dyes with high molecular weight or high activation/sublimation energy. These dyes generally have high colorfastness towards light or laundry processes but nonetheless are difficult to apply through ink jet ink application. In transfer printing processes, this is especially a challenge since high molecular weight disperse dyes can successfully condense and fix onto the synthetic material through migration but are difficult to sublimate. By printing an ink with such a hosted or encapsulated dye molecule or a portion of the molecule into the cyclodextrin structure, heat activation and fixing processes can be much more effective and efficient since there is close contact of the colorant molecules with synthetic materials with high affinity to such colorants. Disperse dyes in this nature include but are not limited to:

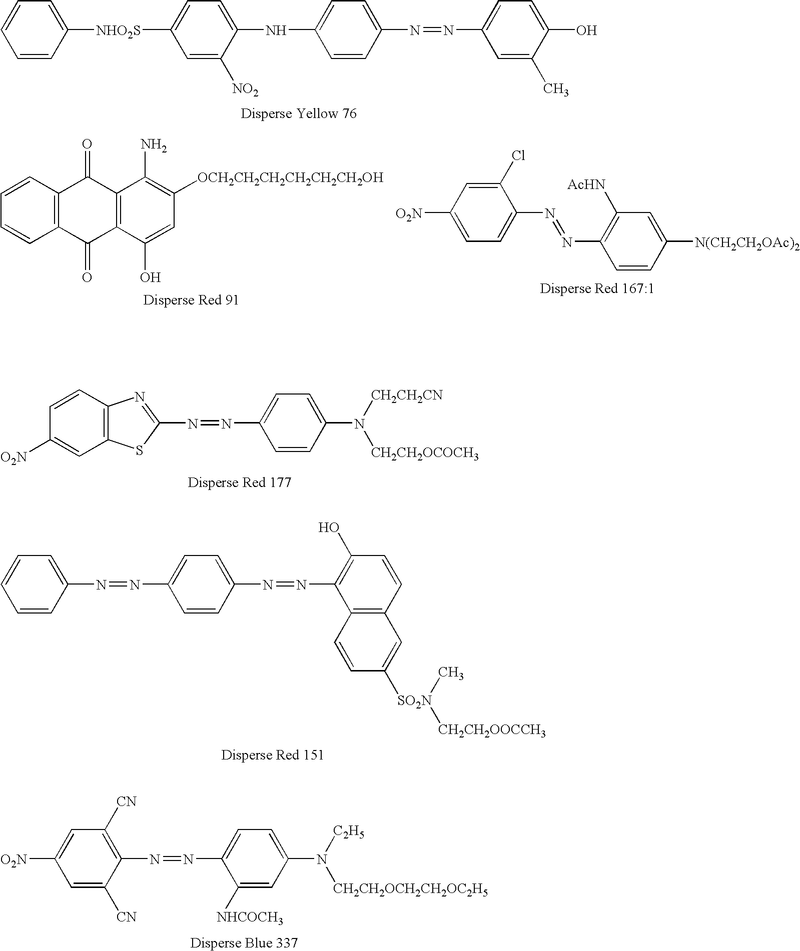

Reactive disperse dyes may also to be used in the present invention. Reactive disperse dyes generally do not contain solubilizing groups and are therefore insoluble or sparingly soluble in water or other solvents. These dyes are typically sublimable upon application of heat. Reactive disperse dyes can react with the hydroxyl or alkyhydroxyl group on cyclodextrin (CD) to form a covalent bond and become solubilized:

Dye-SO₂CH═CH₂+HO-CD→Dye-SO₂CH₂CH₂O—CD

Solubilization of these dyes can also be achieved by introducing these dyes into cyclodextrin (CD) cavities with encapsulation processes and be used in combination with reactive dyes. A subsequent heat activation may sublimate/heat-activated the dye onto synthetic materials such as a polyester compound, and/or bond to a compound with hydroxyl or other active hydrogen functional groups to form a covalent bond.

Further polymerization or chemical grafting processes can be obtained to further alter the property of the cyclodextrin (CD) either prior to the ink forming or after the image printing. For example, esterification of a certain percentage of hydroxyl and alkylhydroxyl functions to enhance the target cyclodextrin's hydrophobicity, whereas converting these functional groups into carboxyl functional groups will increase further the hydrophilic property of the final material.

An ink jet ink comprises a cyclodextrin compound that has been dyed with reactive dyes and/or encapsulated with heat activated or disperse dyes. Typically, a set of ink with cyan, yellow, magenta and black color is used for ink jet printing applications, though special colors such as spot colors can also be used. Cyclodextrin colorant can be used with adjusted amount of each different colorants (reactive dye, heat activated dye) to achieve different final image color intensity. For example, cyclodextrin (CD) with a high percentage hosted heat activated dye should be used for a fabric substrate with high polyester fiber content.

A video camera or scanning device may be used to capture an image. The image is provided to a computer. The computer directs a digital printer, which may be an inkjet printer or other digital imaging device. Other means of forming an image may also be used, including images generated by software. Available computer design graphic application software may be used, or still photographic method may be used. The design may be photographic, graphic artistic, or simply letters or words. The use of cyan, yellow and magenta ink or toner compositions allow the printer or imaging device to generate full color, or multi-color, designs. An optional black ink, or other spot colored ink may also be used to expand the color gamut or create specialty effects.

An image is either printed directly on to the final substrate, or printed on an intermediate substrate, and subsequently transferred. The substrate may be comprised of materials that can be printed upon by an ink jet device, such as a continuous ink jet, drop-on-demand ink jet device such as a thermal ink jet or bubble-jet printer a mechanical or electro-mechanical digital printing or coating device, or a piezoelectric ink jet, ultrasonic ink jet printer.

In direct printing, the inks or toners may be printed directly onto the substrate without substantially activating the reactive components at the time of printing. Aqueous, non-aqueous, or sol-gel type of ink may be used. Inks of other types may also be used, such as hot melt or phase change inks through dye diffusion thermal transfer (D2T2) printer, or phase change ink jet printers.

According to one embodiment of the invention, crosslinking chemicals or crosslinking agents may be used to create covalent bonds between the cyclodextrin and the substrate through chemical reactions such as condensation, esterification, and/or polymerization. These crosslinking reactions can be initiated by either temperature, removing a carrier such as water or volatile chemical agents, or by radiation such as ultraviolet radiation, sonic waves, radio frequency radiation, infrared radiation, cold plasma, or electron beam. Combinations of the above initiation means may also be applied.

The preferred crosslinking chemicals or agents are isocyanates of various types, epoxy crosslinking agents, triazines and aminotriazine such as melamine crosslinking agents, aziridines and polyfunctional aziridines, polyacrylamide, acetoacetoxy-functional polymeric crosslinking agent, Silane coupling agents, cyclic polycarboxylic acid or anhydride, carbonate compound such as alkylene carbonate, and the like. Bifunctional reactive dyes may also be used as either whole or part of the crosslinking agent in fixing and bonding cyclodextrin to the final substrate. Ethylenically unsaturated organic chemicals may be used as crosslinking agent or chain extender when radiation is used to crosslink colorant modified cyclodextrin (CD) onto the substrate. Depending on the substrate to be printed, one type of crosslinking agent may be used, or a combination of several different types may be used. Crosslinking chemicals or agents may be used in the ink contains colorant modified cyclodextrin, or used in the ink contains no cyclodextrin. The printing processes may apply the required portion or ratio of each component, allowing precise and accurate software controls of the degree of the crosslinking reaction.

To further prevent premature or undesired reaction, the crosslinking chemicals or agents may be protected by chemical blocking agents, or by physical blocking mechanism, such as core/shell encapsulation process. Such protections are preferably removed through an initiation means by the application of energy such as heat at the time of fixation or curing. Other means of initiation to remove protection or protecting agent include pressure, radiation, ingredient evaporation, or a combination of more than one means. Internally blocked crosslinking chemicals or agents, sometimes referred as “blocking agent-free” may also be used for the purpose of preventing undesired or premature crosslinking.

The reactive dye applied to the present invention may contain a water-solubilizing group, such as sulfonic acid or carboxylic acid. Examples of reactive dyes include, but are not limited to, those that contain one or more of the following functional groups: monohalogentriazine, dihalogentriazine, 4,5-dichloropyridazone, 1,4-dichlorophthalazine, 2,4,5-trihalogenpyrimidine, 2,3-dichloroquinoxaline, 3,6-dichloropyridazone, sulfuric acid ester of α-hydroxyethylsulfone, N-substituted α-aminoethylsulfone, epoxy group and precursor 2-chloro-1-hydroxyethyl, sulfuric acid ester of α-hydroxypropionamide, α′,α-dibromopropionamide, phosphonic acid and phosphoric acid ester. Specific examples are, for example, those under the trade names Procion H, Procion MX, Primazin P, Reatex, Cibacron T, Levafix E, Solidazol, Remazol, Hostalan, Procinyl, Primazin, Lanasol, Procion T, respectively. Preferred are those containing the monohalogentriazine group. Bifunctional reactive dyes are preferred to be used due to its outstanding color depth and colorfastness on cellulose fibrous materials. Monochloro-triazine masked vinyl sulphone (VS/MCT), monochloro-triazine masked sulphatoethylsulphonyl (MCT/SES) are among the preferred types of bifunctional reactive dyes. Specific examples of bifunctional reactive dyes suitable for the present invention include but not limited to: reactive yellow 145, 160A, reactive orange 122, reactive red 195, 198A, 222, 223, 250, 111, reactive blue 194, 221, 222, and 248.

The heat activated or disperse or sublimation dye suitable for the present invention include those with chemical structure azo, anthraquinone, coumarin, and quinoline. Especially preferred dyes are those with molecular size and shape suitable to be hosted within the cyclodextrin (CD) cavity, either through its chromophore segment or through the side alkyl- or aromatic hydrophobic branch, so that a true solution or stable emulsion or colloidal system can be obtained. Monoazo disperse dyes with the following structure skeleton, for example, may be used.

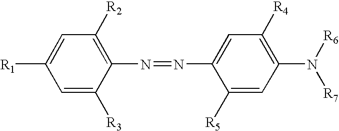

By adjusting the seven functional groups (R₁-R₇), various colors and sizes of the molecule may be obtained.

The final substrate used for present invention may be synthetic or natural, or a combination of the two in various different ratios. For example, blends of cellulose, protein, or polyamide fiber with polyester fiber may be used. The form of the substrate may be film, sheet, knitted, woven, or non-woven fabric/textile, or foam board, so long as the material can be used for either direct printing or transfer printing processes.

In addition to the above listed colorants, the ink may contain an alkaline substance. Examples of alkaline substances used in the present invention include alkali metal hydroxides, such as potassium hydroxide and sodium hydroxide; alkali metal carbonates and bicarbonates, such as sodium carbonate and sodium bicarbonate; amines, such as mono-, di-, and triethanolamines; compounds which form alkaline substances upon application of steam, such as sodium trichloroacetate. Preferred alkaline substances are sodium carbonate and sodium bicarbonate. Also preferred is the use of sodium triacetate, which decomposes to give sodium carbonate upon application of steam and therefore a neutral printing ink may be used.

The inks may also comprise a binder component to enhance the ink rheology and final performance. Typically, the ink binder is the “glue” that holds the ink onto the substrate. Binders can be a single resin or a complex combination of resins, plasticizers, and other additives. Binders impact the viscosity of the system and promote droplet formation. The binder also serve to adhere the colorant to the surface of the substrate, control the gloss of the colorant, control the definition of the print of the colorant, and determine the alkali solubility of the ink, among other purposes. The binders are preferred to be film forming, amorphous, low odor, colorless or pale, and transparent. The binders are either soluble or form a stable emulsion or colloid in the carrier system where surfactants, emulsifiers, humectants and/or co-solvents may be used in the ink. Either structured or random polymers may be selected for use as ink binders. Structured polymers have a block, branched, or graft structure. Particularly preferred are active hydrogen functional binders that can participate in the bonding/crosslinking of the reactive ink.

Aqueous ink formulations contain water as the majority ink carrier. Therefore, binders used in aqueous ink formulations should be water soluble, dispersible or emulsifiable polymers and copolymers. Examples of such binders include phenolics; acrylics such as poly(meth)acrylic acid and salts, polyacrylamide, polystyrene-acrylates; vinyl resins such as polyvinyl alcohol, polyvinyl acetate, and polyvinyl butyral; polyalkyleneoxides such as polyethylene oxide and polyethylene glycol; polyamides; polyamines such as polyvinylpyridine, polyvinylpyrrolidone, polyvinylamine, and polyethyleneimine; cellulose derivatives such as nitrocellulose, ethyl cellulose, ethyl hydroxyethyl cellulose, cellulose acetate butyrate, cellulose acetate propionate, and sodium carboxymethyl cellulose.

Other aqueous ink additives such as water miscible humectants, co-solvents, wetting agents, emulsifiers, solubilizers, charging agents, and dispersants may be used to assist in creating a stable emulsion or colloid of hydrophobic components in the ink suitable for either of the previously mentioned printing systems. Co-solvents may serve several functions. They may act as chain extenders to participate in the crosslinking and bonding reactions. These co-solvents may have two or more functional groups with active hydrogen such as diol, triol, polyol, diamine and polyamine. In some cases, the co-solvent may also perform as a reaction inhibitor or blocking agent, and act as a crosslinking reaction initiator upon its evaporation or removal. They also act as humectants, i.e. they help minimize the evaporation of water and prevent crystallization of the dye/pigment inside the ink jet nozzle. Co-solvents may further help control viscosity and the surface tension of the inks, two very important parameters. The preferred co-solvents used in this invention include but are not limited to N-methyl pyrrolidone/pyrrolidinone and glycols, particularly ethylene glycol such as LEG-1 and LEG-7 (both by Lipo Chemicals), diethylene glycol, propylene glycol, etc., as well as the ethers of such glycols, particularly mono-alkyl ethers. Straight-chain ethers may be more effective viscosity-reducing agents than branched chain isomers, and their efficiency may increase with an increasing number of carbon atoms in the alkoxy groups.

Correctly selected co-solvents may improve the solubility of the cyclodextrin (CD). Furthermore, the use of co-solvents with relatively lower boiling temperature than water may also help improve the stability of the emulsion ink system for a thermal or bubble-jet ink jet system. Such co-solvents enable the quick formation of vaporized bubbles, thereby preventing the breakdown of emulsion particles by the heat from the heating elements, while aiding in inhibiting blocked ingredients in the ink from being unblocked by exposure to heat during the printing process. Examples of such co-solvents include 1-methoxy-2-propanol, iso-propanol, and iso-butyl vinyl ether.

Wetting agents may included, such as fatty acid alkanolamides, oxyethylene adducts from fatty alcohols or fatty amines. Other surface tension modifiers and/or interfacial modifiers include but are not limited to di-, triethanolamine, amine oxide, sulfonated alkyl/fatty ester, aromatic/alkyl phosphate ester.

Common aqueous-based dye/pigment dispersants may also be used to further improve the required physical or fluid-flow dynamics of the ink for the present invention. These dispersants include such compounds as lignin sulfonates, fatty alcohol polyglycol ethers, and aromatic sulfonic acids, for instance naphthalene sulfonic acids. Some dispersants are polymeric acids or bases which act as electrolytes in aqueous solution in the presence of the proper counterions. Such polyelectrolytes may provide electrostatic as well as steric stabilization of dispersed particles in the emulsion. Furthermore, they supply the ink with charging characteristics, if required by the printer application. Examples of polyacids include polysaccharides such as polyalginic acid and sodium carboxymethyl cellulose; polyacrylates such as polyacrylic acid, styrene-acrylate copolymers; polysulfonates such as polyvinylsulfonic acid, styrene-sulfonate copolymers; polyphosphates such as polymetaphosphoric acid; polydibasic acids (or hydrolyzed anhydrides), such as styrene-maleic acid copolymers; polytribasic acids such as acrylic acid-maleic acid copolymers. Examples of polybases include polyamines such as polyvinylamine, polyethyleneimine, poly(4-vinylpyridine); polyquaternary ammonium salts such as poly(4-vinyl-N-dodecyl pyridinium). Amphoteric polyelectrolytes may be obtained by the copolymerization of suitable acidic and basic monomers, for instance, methacrylic acid and vinyl pyridine.

Aqueous inks may also contains pH modifiers; anti-foaming chemicals such as silicone oil emulsions; corrosion inhibitors; fungicides; antifreeze agents, such as ethylene glycol, propylene glycol, glycerol or sorbitol; antioxidants; and UV-light stabilizers.

For non-aqueous ink formulations, the carrier may be based on organic solvents, such as hydrocarbon, alcohol, glycol ethers, glycol esters, ketone, or ester solvents. Alternately, the carrier may be based on natural or synthetic drying or nondrying oils. Preferably reactive carriers contain active hydrogen and are therefore capable of participating crosslinking reaction with the final substrate. Binders used in such inks must be soluble or emulsifiable in these carriers. The ink binder may include resins, plasticizers, and waxes. Typical resins include phenolic resins, rosin modified phenolic resins, alkyd resins, hydrocarbon resins, polystyrene resins and copolymers, terpene resins, silicone resins, alkylated urea formaldehyde resins, alkylated melamine formaldehyde resins, polyamide and polyimide resins, chlorinated rubber and cyclized rubber, vinyl resins, ketone resins, acrylic resins, epoxide resins, polyurethane resins, and cellulose derivative resins. Other additives include surfactants, dispersants, antioxidants, light stabilizers, and drying oil catalysts.

For phase change, or hot melt, ink formulations, hot-melt carriers are used with combinations of hot-melt resins, wax or wax-like materials, tackifying agents, and plasticizers. These materials are solid in form at room temperature but become liquid at the temperature the printer operates, which is generally from 50 to 150 degrees C. Examples of phase change ink carriers include paraffins, microcrystalline waxes, polyethylene waxes, ester waxes, fatty acids, fatty alcohols, fatty amides (usually a mono-amide wax and a tetra-amide resin), sulfonamide materials, resinous materials made from different natural sources (tall oil rosins and rosin esters) and many synthetic resins, oligomers, polymers and co-polymers. A preferred tetra-amide resin is a dimer acid based tetra-amide that is the reaction product of dimer acid, ethylene diamine, and stearic acid. A preferred tackifier resin is a glycerol ester of hydrogenated abietic acid. Other additives may include binders, viscosity modifiers, light stabilizers, anti-oxidants and the like.

Viscosity control of liquid inks allows the ink to print through an ink jet printing device. The viscosity value of the ink may be, for commonly applied ink jet printers, in the range of 1-50 cps, and preferably within a range of 3-20 cps. Ink that is too viscous may result in printing difficulties, poor droplet size or shape forming and control, and/or damaged print orifices.

Surfactants may be used in the processes of wetting, emulsification, solubilization, ink drop forming and surface energy control or modification. Surfactants used for creating oil-in-water type emulsion may include anionic, cationic, nonionic and amphoteric surfactants with various molecular weight values. Surfactants used for non-aqueous based emulsion ink system are preferably the non-ionic type. Depending on the specific HLB (Hydrophillic Lipophillic Balance) values, some surfactants may also be called emulsifiers or emulsifying agents. High HLB value surfactants are generally used for emulsifying oil-in-water or aqueous type of systems, whereas low HLB value surfactants may generally be used to create water-in-oil or non-aqueous type of emulsion systems. Reactive surfactants may also be used including hydroxyl, carboxylic, amine, amidal-terminated copolymeric surfactants.

When the surfactant/emulsifier concentration in a liquid carrier exceeds its critical micelle concentration (CMC), the molecules of the surfactant/emulsifier begin to aggregate. Aggregation of surfactants/emulsifier along with other ingredients forms micelles or reverse micelles, depending the main carrier phase is aqueous or non-aqueous, with a typical structure of non-soluble ingredient particles or aggregates surrounded by surfactant/emulsifier molecule layer. A homogenous, but multi-phase, system is therefore generated with small but isolated droplets of micelles carrying colorants, binders, miscible or non-miscible co-solvents and/or humectants, additives, etc. inside the micelle structure and suspending in the major carrier phase to prevent further aggregation or phase separation. These micelle particles are small enough in size to create a free flow liquid applicable in inkjet printing without clogging the printing mechanism, and also protects the ingredients, especially the heat-sensitive materials inside the micelle particles having a direct contact with each other, and/or having a direct contact with printing mechanisms such as a heating element in thermal or bubble-jet ink jet printing. The non-soluble, non-miscible ingredients used in the application therefore can be stabilized with useable concentrations.

Examples of surfactants and emulsifiers include alkylaryl polyether alcohol nonionic surfactants, such as Triton X series (Octylphenoxy-polyethoxyethanol); alkylamine ethoxylates nonionic surfactants such as Triton FW series, Triton CF-10, and Tergitol (Union Carbide Chemicals); polysorbate products such as Tween (ICI Chemicals and Polymers); polyalkylene and polyalkylene modified surfactants, such as Silwet surfactants (polydimethylsioxane copolymers) and CoatOSil surfactants from OSI Specialties; alcohol alkoxylates nonionic surfactants, such as Renex, BRIJ, and Ukanil; Sorbitan ester products such as Span and Arlacel; alkoxylated esters/PEG-products, such as Tween, Atlas, Myrj and Cirrasol surfactants from ICI Chemicals and Polymers; unsaturated alcohol products such as surfynol series surfactants from Air Products Co., alkyl phosphoric acid ester surfactant products, such as amyl acid phosphate, Chemphos TR-421; alkyl amine oxide such as Chemoxide series from Chemron Corporation; anionic sarcosinate surfactants such as Hamposyl series from Hampshire Chemical corporation; glycerol esters or polyglycol ester nonionic surfactants such Hodag series from Calgene Chemical, Alphenate (Henkel-Nopco), Solegal W (Hoechst AG), Emultex (Auschem SpA); and polyethylene glycol ether surfactants such as Newkalgen from Takemoto Oil and Fat. Co. and other commercial surfactants known to the skilled in the art.

In addition to creating a stable emulsion or colloid ink system, surfactants are also used for surface energy or surface tension control. In either an aqueous or non-aqueous case, the surface tension of the final ink should range from 20 dyne/cm to 55 dyne/cm and preferably from 35 dyne/cm to 45 dyne/cm.

Thermally expandable inks may be produced in which the ink and/or the medium comprises an expanding agent. Simultaneous expanding and cross-linking gives a three-dimensional image which is permanently bound to the substrate. The height of the image is dependent on the concentration of expanding agent, the temperature and the pressure applied during heat transfer printing.

Preferable expanding agents include those which decompose upon heating to release gaseous products which cause the ink to expand. Such expanding agents, known as chemical blowing agents include organic expanding agents such as azo compounds which include azobisisobutyronitrile, azodicarbonamide, and diazoaminobenzene, nitroso compounds such as N,N′-dinitrosopentamethylenetetramine, N,N′-dinitroso-N,N′-dimethylterephthalamide, sulfonyl hydrazides such as benzenesulfonyl hydrazide, p-toluenesulfonyl hydrazide, p-toluenesulfonyl azide, hydrazolcarbonamide, acetone-p-sulfonyl hydrazone; and inorganic expanding agents, such as sodium bicarbonate, ammonium carbonate and ammonium bicarbonate. Such expanding agents may be dissolved or dispersed in the colored ink, in a separate ink reservoir, coated on the intermediate medium, or a combination of the above.

Thermally expandable inks may alternately be produced by the use of volatile hydrocarbons encapsulated in a microsphere that ruptures upon the application of heat. The gaseous products released expand the ink. These thermally expandable microcapsules are composed of a hydrocarbon, which is volatile at low temperatures, positioned within a wall of thermoplastic resin. Examples of hydrocarbons suitable for practicing the present invention are methyl chloride, methyl bromide, trichloroethane, dichloroethane, n-butane, n-heptane, n-propane, n-hexane, n-pentane, isobutane, isophetane, neopentane, petroleum ether, and aliphatic hydrocarbon containing fluorine such as Freon, or a mixture thereof.

Materials which are suitable for forming the wall of the thermally expandable microcapsule include polymers of vinylidene chloride, acrylonitrile, styrene, polycarbonate, methyl methacrylate, ethyl acrylate and vinyl acetate, copolymers of these monomers, and mixtures of the polymers of the copolymers. A crosslinking agent may be used as appropriate.

The microcapsules may be dispersed or emulsified in a colored ink, in a separate ink reservoir, coated on the intermediate medium, or a combination of the above. The diameter of the thermally expanded microcapsule is in the range of 0.01-20 microns, and preferably within a range of 0.1-5 microns, with a greater preference of a range of 0.1-1 microns.

It may be advantageous to include a catalyst to catalyze the cross-linking reaction and to help the control of the reaction of cross-linking or bonding of the image to the final substrate. Examples of catalysts include organic acids, tertiary amines, such as triethylene amine, triethylenediamine, hexahydro-N,N′-dimethyl aniline, tribenzylamine, N-methyl-piperidine and N,N′-dimethylpiperazine; heterocyclic nitrogen compounds, such as 1,5-diazobicyclo[4.3.0]non-5-ene and diazobicyclo[2.2.2]octane; alkali or alkaline earth metal hydroxides; heavy metal ions, such as iron(III), manganese(III), vanadium(V) or metal salts such as lead oleate, lead-2-ethylhexanolate zinc(II) octanoate, lead and cobalt naphthenate, zinc(II)-ethylhexanoate, dibutyltin dilaurate, dibutyltin diacetate, and also bismuth, antimony and arsenic compounds, for example tributyl arsenic, triethylstilbene oxide or phenyldichlorostilbene. Preferably, the current invention uses blocked catalysts that can catalyze a chemical reaction of cross-linking and bonding only at a desired condition reached. Examples of such blocked catalysts include but not limited to Nacure® 2547, Nacure® 4575, and Nacure® 4167 (King Industries). The use of catalyst is most desirable when the final activation condition is harsh and the final substrate is sensitive to such harsh conditions. Biological or enzymatic catalyst may also be used when the crosslinking or bonding reaction involves protein-containing such as wool, silk, or soybean protein fibrous (SPF) materials.

What is claimed is:

1. A method of digital printing, comprising the steps of:
a. preparing a liquid reactive ink comprising cyclodextin and reactive dye;
b. supplying a digital printer with said reactive ink;
c. digitally printing said reactive ink on a substrate; and
d. subsequently reacting said ink to bond to said substrate

2. A method of digital printing as described in claim 1, wherein said cyclodextrin is chemically modified cyclodextrin.

3. A method of digital printing as described in claim 1, wherein said reactive ink further comprises heat activated dye.

4. A method of digital printing as described in claim 1, Wherein said reactive ink comprises a crosslinking agent.

5. A method of digital printing as described in claim 4, wherein said reactive ink further comprises blocked catalyst.
